(19) United States
(12) Patent Application Publication
(10) Pub. No.: US 2017/0092923 A1
(43) Pub. Date: Mar. 30, 2017

(54) BATTERY CELLS HAVING NOTCHED ELECTRODES

(71) Applicant: Apple Inc., Cupertino, CA (US)

(72) Inventors: Christopher R. Pasma, Mountain View, CA (US); Stephen J. Wisler, San Francisco, CA (US); Brian K. Shiu, Sunnyvale, CA (US); Yuriy Londarenko, San Jose, CA (US)

(21) Appl. No.: 15/260,591

(22) Filed: Sep. 9, 2016

Related U.S. Application Data
(60) Provisional application No. 62/234,460, filed on Sep. 29, 2015.

(51) Int. Cl. H01M 2/18; H01M 2/16; H01M 2/08

(52) U.S. Cl. CPC H01M 2/18; H01M 2/08; H01M 2/1673; H01M 2220/30; H01M 2004/021

(57) ABSTRACT

Battery cells are presented that have notched electrodes. In one embodiment, the battery cells have a first notch in an electrode and a second notch in a seal. The second notch allows a first portion of the seal adjacent the first edge to fold without overlapping a second portion of the seal adjacent the second edge. The first notch serves as a relief zone that enables the seal to maintain a seal distance during folding. In another embodiment, the battery cells have a first notch in an electrode and a second notch in a portion of a separator. The first notch and the second notch, in combination, allow the separator to fold along a fold line without tearing. Other battery cells are presented.

### CROSS-REFERENCE TO RELATED PATENT APPLICATIONS

This patent application claims the benefit under 35 U.S.C. §119(e) of U.S. Patent Application No. 62/234,460, entitled “BATTERY CELLS HAVING NOTCHED ELECTRODES,” filed on Sep. 29, 2015, which is incorporated herein by reference in its entirety.

### FIELD

This disclosure relates generally to battery cells, and more particularly, to battery cells having notched electrodes.

### BACKGROUND

Battery cells can utilize rectangular packaging shapes. However, these battery cells are often targeted for operating environments that do not offer mating pockets that are rectangular. As such, unused space may result when a rectangular battery cell occupies a pocket having a different shape, a different scale, or some combination thereof. Such unused space represents a wasted volume that otherwise could have been filled to increase a storage and delivery capacity of the battery cell.

In the battery industry, packaging shapes are being increasingly explored to increase pocket utilization within an operating environment (e.g., within portable electronics). Such increases may involve designing a non-rectangular packaging shape in view of a non-rectangular pocket, or vice versa. Design of the non-rectangular packaging shape may also involve changing a shape of electrodes within the battery cell to allow the non-rectangular packaging shape.

### SUMMARY

In various aspects, the description is directed to battery cells having notched electrodes. In various embodiments, a battery cell includes an electrode having a first edge and a second edge. The first edge and the second edge meet at a virtual intersection. A first notch is in the electrode at an offset distance from the virtual intersection. The battery cell also includes a seal adjacent the first edge, the first notch, and the second edge. The seal has a fold line that is displaced a first seal distance from the first edge and displaced a second seal distance from the second edge. The first and second seal distances can be the same or different. Each offset distance of the fold line from the first edge and second edge can be equal to or greater than the seal distance. A second notch is in the seal opposite the first notch (and/or proximate to the virtual intersection) to create a relief for a first portion of the seal adjacent the first edge of the electrode to fold without overlapping a second portion of the seal adjacent the second edge of the electrode.

In some embodiments, the battery cell includes an electrode and a separator with a non-rectangular shape. The electrode has a first edge and a second edge that meet at a first virtual intersection. The battery cell also includes a first notch in the electrode at an offset distance from the first virtual intersection. A portion of a separator extends along the first edge, the first notch, and the second edge of the electrode and has a fold line. The portion of the separator and the fold line meet at, respectively, a second virtual intersection and a third virtual intersection. The battery cell additionally includes a second notch in the portion of the separator. The second notch encompasses at least the second virtual intersection and the third virtual intersection to create a relief in the portion of the separator extending along the first edge, the first notch and the second edge.

In some embodiments, the battery cell includes an electrode, a separator and a seal with a non-rectangular shape. The electrode has a first edge and a second edge that meet at a first virtual intersection. A first notch is in the electrode at an offset distance from the first virtual intersection. The offset distance is equal to or greater than the seal distance, thereby allowing the first notch to maintain the seal distance proximate to the first virtual intersection. The battery cell also includes a seal adjacent the first edge, the first notch, and the second edge. The seal has a seal fold line displaced at a first seal distance from the first edge and a second seal distance from the second edge. The battery cell additionally includes a second notch in the seal proximate to the first virtual intersection and opposite first notch. The second notch creates a relief to allow a first portion of the seal adjacent the first edge of the electrode to fold without overlapping a second portion of the seal adjacent the second edge of the electrode. Meanwhile, the separator has a portion that extends along the first edge, the first notch, and the second edge and has a separator fold line. The portion of the separator and the separator fold line meet at, respectively, a second virtual intersection and a third virtual intersection. A third notch is in the portion of the separator and encompasses at least the second virtual intersection and the third virtual intersection to create a relief in a portion of the separator.

Other battery cells having notched electrodes are presented.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A is a schematic top view of a portion of a battery cell having an electrode, but at an outer corner, in accordance with embodiments of this disclosure.

FIG. 1B is a schematic top view of a portion of a battery cell having an electrode, but at an inner corner, in accordance with embodiments of this disclosure.

FIG. 2 is a schematic top view is presented of a portion of a battery cell having an electrode and a separator, in accordance with embodiments of this disclosure.

FIG. 3 is a perspective view of a battery cell having a non-rectangular housing, in accordance with embodiments of this disclosure.

FIG. 4 is a side view of a portion of a battery cell with a single side sealing fold, in accordance with embodiments of this disclosure.

FIG. 5 is a side view of a portion of a battery cell with a double side sealing fold, in accordance with embodiments of this disclosure.

FIG. 6 is perspective view of a corner portion of a battery cell, in accordance with the embodiments of this disclosure.

### DETAILED DESCRIPTION

In general, a battery cell utilizes a housing to enclose an electrode therein (among other components). The housing isolates the electrode from an ambient environment of the battery cell and commonly includes a seal. The seal (or a portion thereof) facilitates closure of the housing during manufacture, i.e., after the electrode has been disposed into the housing. The seal may run along a perimeter of the housing and may be formed into a flat seal or a flange seal. Protrusion of the seal from the housing is undesirable and subtracts from a volume that would otherwise be available to increase a power capacity of the battery cell. To reduce wasted volume, the seal—when formed into the flat seal or the flange seal—is subsequently folded. However, corners are often prevalent along the perimeter, especially for battery cells having a non-rectangular shape. These corners present challenges in maintaining integrity of the seal during folding. Such challenges may be addressed by forming a first notch in the electrode and a second notch in the seal proximate to such corners.

As used herein, the term “non-rectangular” refers to a perimeter having any number sides and corners that do not define a rectangular (or square) shape. The sides of the perimeter may be straight or curved. Moreover, the corners may include any combination of inner corners and outer corners. Inner corners are formed when adjacent sides of the perimeter meet at a juncture and have an angle exterior to the perimeter that is less than 180°. Outer corners are formed when adjacent sides of the perimeter meet at a juncture and have an angle exterior to the perimeter that is greater than 180°.

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

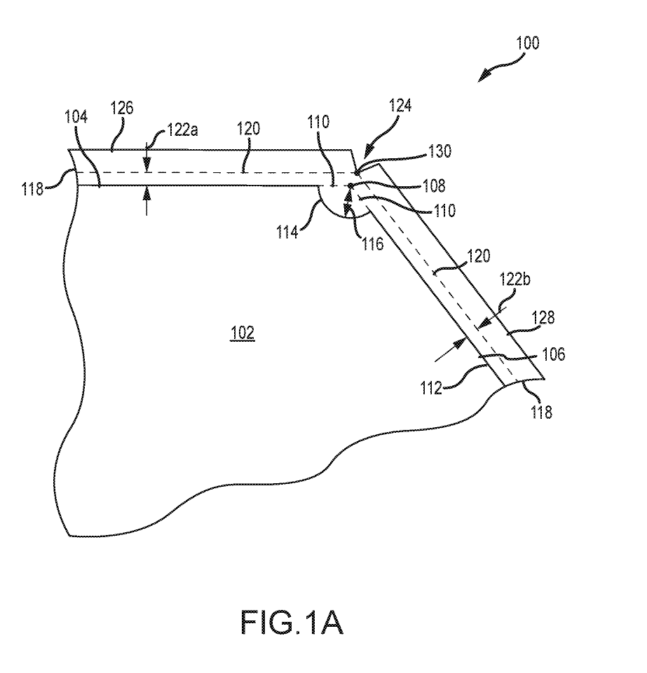

Now referring to FIGS. 1A & 1B, a schematic top view is presented of a portion of a battery cell 100 having an electrode 102, in accordance with embodiments of this disclosure. FIGS. 1A & 1B depict the portion of the battery cell 100 in the context of, respectively, an outer corner and an inner corner. The electrode 102 has a first edge 104 and a second edge 106 that meet at a virtual intersection 108. The virtual intersection 108 defines a juncture where the first edge 104 and the second edge 106 would meet if extended beyond their existing lengths to form a corner. In FIGS. 1A & 1B, such extensions (i.e., hypothetical extensions) are illustrated by dotted lines 210. The first edge 104 and the second edge 106 may define a portion 112 of a perimeter that, when disposed in the battery cell 100, abuts against a housing thereof.

A first notch 114 is in the electrode 102 at an offset distance 116 from the virtual intersection 108. In FIGS. 1A & 1B, the first notch 114 is depicted as equidistant from the virtual intersection 108 at all points (i.e., equidistant by the offset distance 116). However, this depiction is not intended as limiting. Other profiles are possible for the first notch 114. In general, the first notch 114 may be shaped such that all points thereon are separated from the virtual intersection 108 by at least the offset distance 116.

The battery cell 100 includes a seal 118 extending along the first edge 104, the first notch 114, and the second edge 106. The seal 118 may be in a housing of the battery cell 100 and may be a flat seal (or flange seal). The seal 118 has a fold line 120 displaced at a first seal distance 122a from the first edge 104, and a second seal distance 122b from the second edge 106. The offset distance 116 is equal to or greater than each of the first seal distance 122a and the second seal distance 122b. The first seal distance 122a and the second seal distance 122b can be same to each other (as depicted), while in other embodiments, the first seal distance and the second seal distance can be different. In FIGS. 1A & 1B, the fold line 120 is depicted by a dashed line. First seal distance 122a and/or second seal distance 122b may serve as a minimum seal distance around the portion 112 of the perimeter. In this capacity, first seal distance 122a and/or second seal distance 122b may ensure integrity of the seal 118 during operation of the battery cell 100. For example, and without limitation, seal distance 122a and seal distance 122b may provide that the seal 118 resists swelling of the electrode 102 during cycles associated with charging and discharging of the battery cell 100.

In some embodiments, an exclusion area is associated with the virtual intersection 108. In these embodiments, the exclusion area encircles the virtual intersection 108. The second notch 124 is prohibited from extending into the exclusion area. In some embodiments, the seal 118 is a flat seal formed into a pouch. In these embodiments, the electrode 102 is disposed into the pouch.

The battery cell also includes a second notch 124 in the seal 118 proximate the virtual intersection 108 and opposite the first notch 114. A first portion 126 of the seal 118 is adjacent the first edge 104 and a second portion 128 of the seal is adjacent the second edge 106. The second notch 124 creates a relief to allow a first portion 126 to fold without overlapping a second portion 128. The second notch 124 may terminate a fold point 130 defined by a juncture of the fold line 120. In FIG. 1A, the second notch 124 is depicted as having a “V-shape” with an apex that terminates at the fold point 130. In FIG. 1B the second notch is depicted as a slit that terminates at the fold point 130. However, these depictions are not intended as limiting. The second notch 124 may be any shape that maintains first seal distance 122a and second seal distance 122b while allowing the first portion 126 to fold without overlapping the second portion 128. In some embodiments, the second notch 124 is defined by a border that includes the virtual intersection 108. In further embodiments, the border includes an apex positioned at the virtual intersection 108.

In operation, the first portion 126 and the second portion 126 are folded along the fold line 120. Such folding may include folding towards, respectively, the first edge 104 and the second edge 106. Other directions of folding, however, are possible. The second notch 124 enables the first portion 124 and the second portion 126 to fold independently of each other and without contact (i.e., without overlap). It will be appreciated that folding may generate stress within the seal 118 along the fold line 120. Such stress may concentrate at the fold point 130 where the first portion 124 and the second portion 126 meet (e.g., at an apex of the second notch 124). The first notch 114 allows the seal 118 to extend into an area created by the offset distance 116. Thus, if stress during folding causes local failure of the seal 118 around the fold point 130, the area is able to bridge continuity of the seal 118 along the portion 112 of the perimeter.

It will be appreciated that, in general, battery cells also include a separator disposed on an electrode, which may include the separator being interposed between two electrodes. Such interposing is also common within a stack of electrodes, which is typically formed by a sequence of layers that alternates between electrode and separator. In some embodiments, the electrode and the separator share a common outline or “footprint.” In some embodiments, the electrode and the separator share a common outline or “footprint,” but the separator is slightly larger in scale and therefore extends past the electrode. This extension generates a protrusion along the common outline. During manufacture, the protrusion of the separator is folded against the electrode to minimize a non-functional volume of the electrode stack. Adjacent inner corners, however, the separator lacks sufficient material to completely fold without tearing (i.e., due to a poor ability to stretch). To prevent tearing, the separator may involve a notch therein adjacent an inner corner. The notch in the separator is complemented by a corresponding notch in the electrode, which provides a relief against a tear propagating out of the notch in the separator.

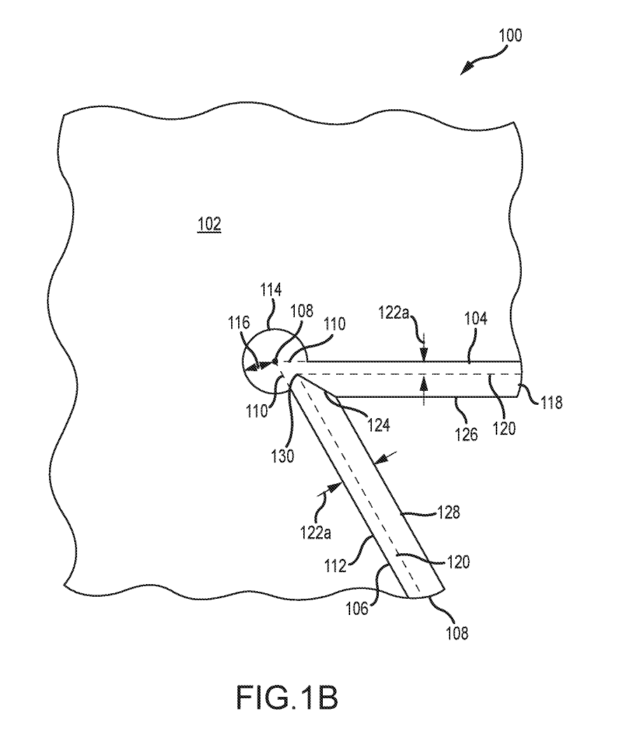

Now referring to FIG. 2, a schematic top view is presented of a portion of a battery cell 200 having an electrode 202 and a separator 204, in accordance with embodiments of this disclosure. The separator 204 may protrude past the electrode 202. A non-limiting example of such protrusion is shown in FIG. 2. The electrode 202 is non-rectangular in shape and has a first edge 206 and a second edge 208 that meet at a first virtual intersection 210. The first virtual intersection 210 defines a first juncture where the first edge 206 and the second edge 208 would meet if extended beyond their existing lengths to form a first corner. In FIG. 2, such (hypothetical) extensions are illustrated by dotted lines. The first edge 206 and the second edge 208 may define a portion 212 of a perimeter that, when disposed in the battery cell 200, abuts against a housing thereof. In some embodiments, such as that shown in FIG. 2, the first virtual intersection 210 defines an inner corner 214 of the electrode 202.

A first notch 216 is in the electrode 202 at an offset distance 218 from the first virtual intersection 210. In FIG. 2, the first notch 216 is depicted as equidistant from the virtual intersection 210 at all points (i.e., equidistant by the offset distance 218). However, this depiction is not intended as limiting. Other profiles are possible for the first notch 216. In general, the first notch 216 may be shaped such that all points thereon are separated from the virtual intersection 210 by at least the offset distance 218.

The separator 204 has a portion 220 extending along the first edge 206, the first notch 216, and the second edge 208. The portion 220 has a fold line 222, which in FIG. 2 is depicted by a dashed line. The portion 220 of the separator 204 and the fold line 222 meet at, respectively, a second virtual intersection 224 and a third virtual intersection 226. The second virtual intersection 224 defines a second juncture where adjacent edges of the separator 204 would meet if extended beyond their existing lengths to form a second corner. The third virtual intersection 226 defines a third juncture where adjacent fold lines 222 would meet if extended beyond their existing lengths to form a third corner. In FIG. 2, such extensions (i.e., hypothetical extensions) are illustrated by dotted lines. In some embodiments, the electrode 202 and the portion 220 of the separator 204 are disposed in a pouch.

A second notch 228 is in the portion 220 of the separator 204 and encompasses at least the second virtual intersection 224 and the third virtual intersection 226. The second notch 228 may be a slit, a “V-shaped” notch, a “U-shaped” notch, or some other shape. In FIG. 2, the second notch 228 is depicted as the “U-shaped” notch. However, this depiction is for purposes of illustration only. In some embodiments, the second notch 228 encompasses the first virtual intersection 210.

In operation, the portion 220 of the separator 204 is folded along the fold line 222, which may include folding towards the electrode 202. The second notch 228 enables adjacent portions of the separator 204 to fold independently of each other and without “pulling” on neighboring material (i.e., around the second virtual intersection 224 and the third virtual intersection 226). Such independent folding may prevent tearing of the separator 204. This benefit may be useful when the electrode 202 and the separator 204 are disposed into the housing of the battery cell 200 (e.g., when the portion 212 of the perimeter abuts against the housing). Other benefits, however, are possible.

It will be appreciated that embodiments described in relation to FIGS. 1A & 1B can be combined at a single corner with those described in relation to FIG. 2. According to an illustrative embodiment, a battery cell includes an electrode having a first edge and a second edge that meet at a first virtual intersection. A first notch is in the electrode at an offset distance from the first virtual intersection. The battery cell also includes a seal adjacent the first edge, the first notch, and the second edge. The seal has seal fold line displaced at a first seal distance from the first edge and a second seal distance from the second edge. The first and second seal distances can be the same or different. The offset distance is equal to or greater than the seal distance, thereby allowing the first notch to maintain the seal distance proximate to the first virtual intersection. The battery cell additionally includes a separator having a portion that extends along the first edge, the first notch, and the second edge. The portion has a separator fold line. The portion of the separator and the separator fold line meet at, respectively, a second virtual intersection and a third virtual intersection.

The battery cell additionally includes a second notch in the seal proximate to the first virtual intersection and opposite first notch. The second notch creates a relief to allow a first portion of the seal adjacent the first edge to fold without overlapping a second portion of the seal adjacent the second edge. A third notch is in the portion of the separator and encompasses at least the second virtual intersection and the third virtual intersection. It will be appreciated that the third notch creates a relief that allows the separator to fold along the separator fold line without tearing. By way of illustration, the relief allows for a portion of the separator extending along the first edge to fold independent of a portion extending along the second edge.

In some embodiments, the seal distance is not greater than 1 mm. In some embodiments, the seal distance is at least 0.5 μm. In some embodiments, the second notch comprises an apex positioned at the first virtual intersection. In some embodiments, the portion of the separator is folded along separator fold line. In further embodiments, the electrode and the portion of the separator are disposed into a housing of the battery cell. In some embodiments, the portion of the separator is folded along separator fold line and the seal is flat seal formed into a pouch. In these embodiments, the electrode and the portion of the separator are disposed into the pouch.

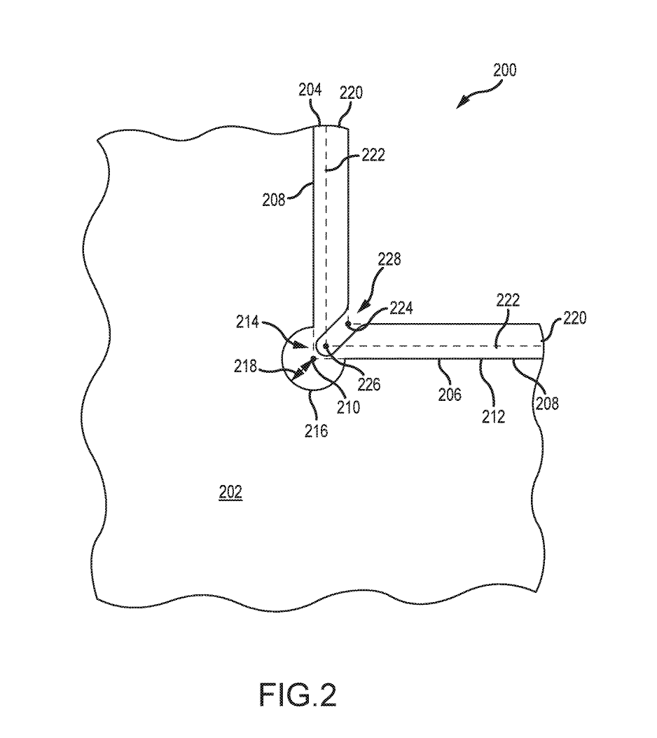

Now referring to FIG. 3, a perspective view is presented of a battery cell 300 having a non-rectangular housing 302, in accordance with embodiments of this disclosure. The battery cell 300 includes inner corners 304 and outer corners 306 along a perimeter 308 of the non-rectangular housing 302. A seal 310 extends along a portion of the perimeter 308 and is folded towards the non-rectangular housing 302 and terminals 316 extend from the housing 302 beyond the seal 310 to allow for electrical connections to the battery cell 300. The terminals 316 can be can be a negative or positive tab. The battery cell 300 also includes an electrode stack disposed within the non-rectangular housing 302 (i.e., not shown). The electrode stack is formed of an alternating sequence of electrodes and separators, which may include electrode layers interposed by separator layers. Neighboring electrodes in the electrode stack may alternate between cathode functionality and anode functionality. The non-rectangular housing 308 conforms in shape to instances of a first notch 310 in the electrode stack (or electrode). Shapes associated with instances of the first notch 310 are depicted in FIG. 3 for purposes of illustration only and are not intended as limiting. Other shapes are possible.

A seal 312 extends along a portion of the perimeter 308 and is folded towards the non-rectangular housing 302. The seal 312 contains instances of a second notch 314 formed therein that enables folding of the seal 312 adjacent the inner corners 304 and the outer corners 306. Instances of the first notch 310 and instances of second notch 314 function, in combination, to allow the seal 312 to fold while maintaining a seal distance adjacent the corners 304, 306. The electrode stack within the non-rectangular housing 302 may contain separators that protrude past neighboring electrodes. To enable folding of these separators, instances of a third notch (not shown) may be formed in the separators. Such instances may be adjacent the inner corners 304 and opposite instances of the first notch 310 in the electrode stack (or electrode). In combination, instances of the third notch and instances of the first notch 310 allow the separators to fold without tearing in a vicinity of the first corners 304.

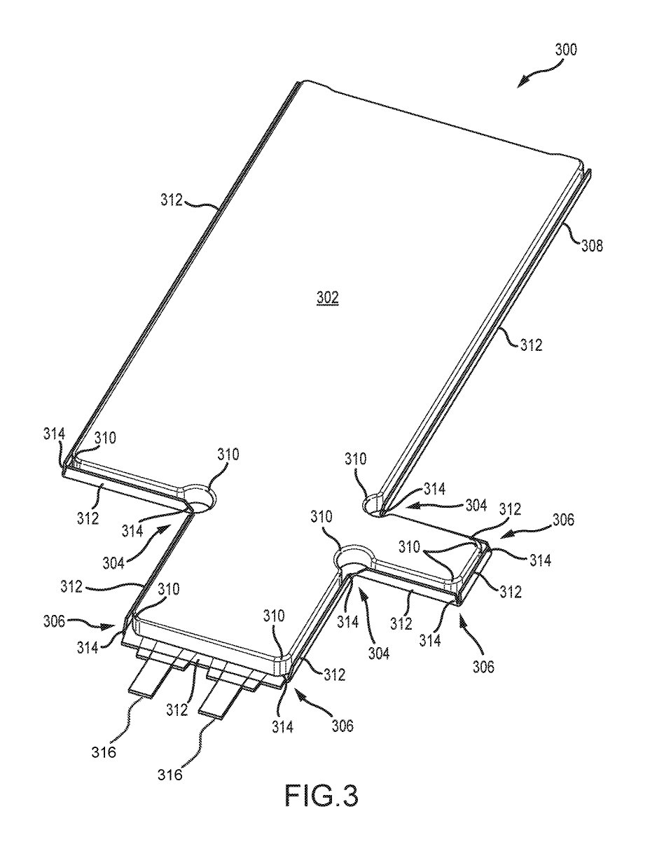

Now referring to FIG. 4, a side view is presented of a battery cell 400 having a single side fold, in accordance with embodiments of the disclosure. The battery cell includes housing 402. A seal 410 extends along a portion of the perimeter 408 and is folded towards the non-rectangular housing 402. More particularly, the seal 410 is a single side fold that is folded in an upwards direction. For example, as illustrated in FIG. 4, housing 402 may be a pouch having an upper portion 402a and a lower portion 402b. The upper portion 402a and lower portion 402b may also include upper and lower extensions 403a and 403b, respectively. Upper and lower extensions 403a and 403b aid in facilitating sealing of the pouch. To seal the pouch, upper portion 402a and 402b include are joined along seal 410. However after sealing, upper and lower extensions 403a and 403b can extend beyond the perimeter 408 of housing 402 and be an unused space that represents wasted volume when battery cell 400 is incorporated into devices. To minimize the wasted volume within devices, the upper and lower extensions 403a and 403b are folded upwards to be adjacent a side 402c of housing, thereby reducing protrusions from battery cell 400, which eases the packaging constraints imposed by battery cell 400. Folding of upper and lower extensions 403a and 403b also has the benefit of reducing manufacturing cost, as it reduces the need to trim or cut the extension.

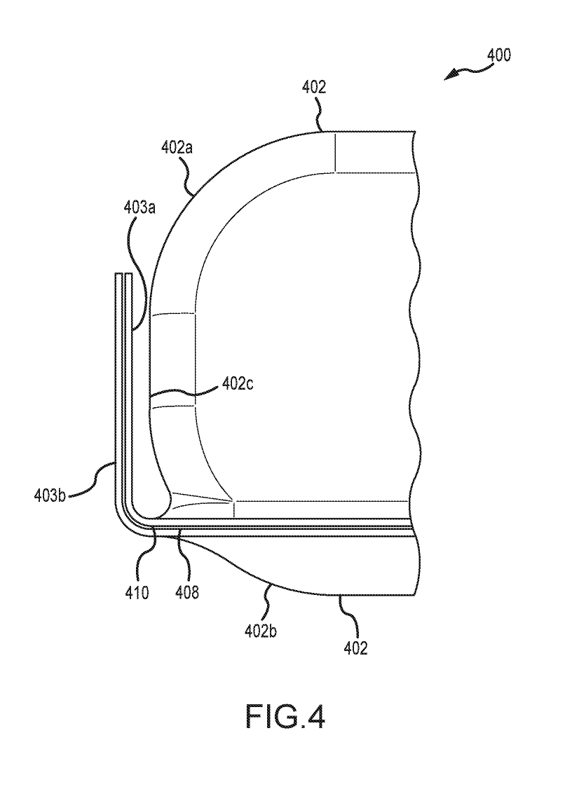

In other embodiments, as illustrated in FIG. 5, the housing can have a double side fold. FIG. 5 is a side view of a battery cell 500 having a double side fold, in accordance with embodiments of the disclosure. The battery cell includes housing 502. A seal 510 extends along a portion of the perimeter 508 and is folded towards the non-rectangular housing 502. More particularly, the housing 508 has a first portion folded in an upwards direction and then a second portion folded in a downwards directed to create a double side fold. For example, as illustrated in FIG. 5, housing 502 may be a pouch having an upper portion 502a and a lower portion 502b. The upper portion 502a and lower portion 502b may also include upper and lower extensions 503a and 503b, respectively. Upper and lower extensions 503a and 503b aid in facilitating sealing of the pouch. To seal the pouch, upper portion 502a and 502b, including extensions 503a and 503b, are joined along seal 410. Like housing 402, upper and lower extensions 503a and 503b can extend beyond the perimeter 508 of housing 502 and be an unused space that represents wasted volume when battery cell 500 is incorporated into devices. Thus to minimize the wasted volume within devices, the upper and lower extensions 503a and 503b are folded to be adjacent a side 502c of housing, thereby reducing protrusions from battery cell 400.

Further, to enhance the durability of seal 510, the upper and lower extensions 503a and 503b can be folded twice to have a double fold. In other words, the upper and lower extensions 503a and 503b have first portions 513a and 513b, respectively, that are folded in an upwards direction and second portions 523a and 523b, respectively, that extend for the first portions 513a and 513b, which is folded in a downwards direction creating elbow joint 525, thereby reducing the chances the seal 510 will separate.

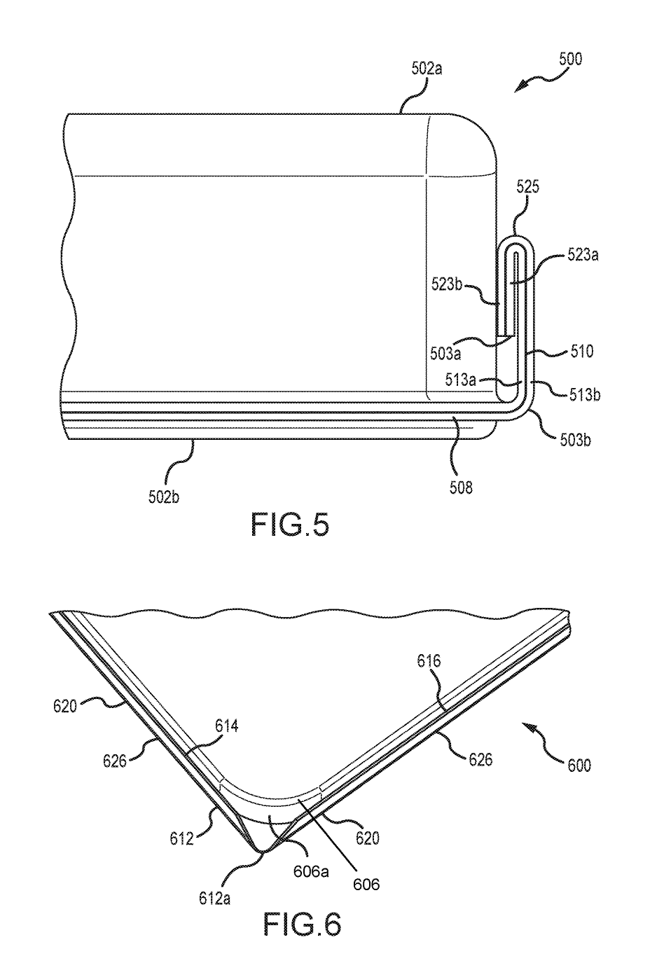

Now referring to FIG. 6, is a corner portion of a battery cell 600 having a corner geometry in accordance with embodiments of this disclosure. Corner 606 of battery 600 includes a radiused (i.e. rounded) portion 606a and a chamfered portion 612a (i.e., sloping surface at the corner). To create chamfered portion 612a, the seal 612 can be cut along the edge 612b of the corner, thereby facilitating folding of the seal at the outer corner.

Similar to seal 118 shown in FIG. 1A, a first portion 626 of the seal 612 is adjacent a first edge 614 and a second portion 628 of the seal is adjacent the second edge 616. The chamfer creates a relief to allow the first portion 626 of the seal to fold without overlapping a second portion 628. In operation, the first portion 626 and the second portion 628 are folded along a fold line 620. Such folding may include folding towards, respectively, the first edge 614 and the second edge 616. Other directions of folding, however, are possible.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A battery cell, comprising:
an electrode comprising a first edge and a second edge that meet at a virtual intersection;
a first notch in the electrode at an offset distance from the virtual intersection;
a seal adjacent to the first edge, the first notch, and the second edge of the electrode and having a fold line, the fold line displaced at a first seal distance from the first edge and a second seal distance from the second edge;
a second notch in the seal opposite the first notch to create a relief for a first portion of the seal adjacent the first edge to fold without overlapping a second portion of the seal adjacent the second edge; and
wherein the offset distance is equal to or greater than each of the first and the second seal distance.

2. The battery cell of claim 1, wherein the electrode has a non-rectangular shape.

3. The battery cell of claim 1, wherein the virtual intersection occurs at an inner corner and the first notch is a slit.

4. The battery cell of claim 1, wherein the seal is a flat seal formed into a pouch and wherein the electrode is disposed into the pouch.

5. The battery cell of claim 1, wherein the first seal distance and the second seal distance are not greater than 1 mm.

6. The battery cell of claim 1, wherein the first seal distance and the second seal distance are at least 0.5 μm.

7. The battery cell of claim 1, wherein the electrode and the seal are disposed within a pouch.

8. A battery cell, comprising:
an electrode with a non-rectangular shape and having a first edge and a second edge that meet at a first virtual intersection;
a first notch in the electrode at an offset distance from the first virtual intersection;
a separator having a portion extending along the first edge, the first notch, and the second edge and having a fold line, the portion of the separator and the fold line meeting at, respectively, a second virtual intersection and a third virtual intersection; and
a second notch in the portion of the separator and encompassing at least the second virtual intersection and the third virtual intersection to create a relief in the portion of the separator extending along the first edge, the first notch, and the second edge.

9. The battery cell of claim 8, wherein the portion of the separator protrudes past the electrode.

10. The battery cell of claim 8, wherein the first virtual intersection defines an inner corner of the electrode.

11. The battery cell of claim 8, wherein the electrode and the portion of the separator are disposed within a pouch.

12. The battery cell of claim 8, wherein the second notch encompasses the first virtual intersection.

13. The battery cell of claim 8, wherein the second notch comprises a slit.

14. A battery cell, comprising:
an electrode with a non-rectangular shape and having a first edge and a second edge that meet at a first virtual intersection;
a first notch in the electrode at an offset distance from the first virtual intersection;
a seal adjacent along the first edge, the first notch, and the second edge and having a seal fold line, the seal fold line displaced at a first seal distance from the first edge and a second seal distance from the second edge;
a second notch in the seal opposite the first notch to create a relief for a first portion of the seal adjacent the first edge to fold without overlapping a second portion of the seal adjacent the second edge;
a separator having a portion extending along the first edge, the first notch, and the second edge and having a separator fold line, the portion of the separator and the separator fold line meeting at, respectively, a second virtual intersection and a third virtual intersection;
a third notch in the portion of the separator and encompassing at least the second virtual intersection and the third virtual intersection to create a relief in the portion of the separator extending along the first edge, the first notch, and the second edge; and
wherein the offset distance is equal to or greater than each of the first seal distance and the second seal distance.

15. The battery cell of claim 14, wherein the portion of the separator is folded along the separator fold line.

16. The battery cell of claim 15, wherein the electrode and the portion of the separator are disposed into a housing of the battery cell.

17. The battery cell of claim 15, wherein the seal is a flat seal formed into a pouch and wherein the electrode and the portion of the separator are disposed into the pouch.

18. The battery cell of claim 14, wherein the first seal distance and the second seal distance are not greater than 1 mm.

19. The battery cell of claim 14, wherein the first seal distance and the second seal distance are at least 0.5 μm.

20. The battery cell of claim 14, wherein the second notch comprises an apex positioned at the first virtual intersection.
